(19) United States
(12) Patent Application Publication
(10) Pub. No.: US 2026/0359118 A1
(43) Pub. Date: Nov. 12, 2026

(54) COMPUTATIONAL TASK PLACEMENT USING A PREDICTIVE MODEL

(71) Applicant: Dell Products L.P., Round Rock, TX (US)

(72) Inventors: Pradyumna Kumar Prusty, JAJPUR (IN); Kailash Talreja, MUMBAI (IN); Saurabh Jha, Austin, TX (US)

(21) Appl. No.: 19/094,313

(22) Filed: Mar. 28, 2025

(51) Int. Cl. G06F 9/50; G06N 3/092

(52) U.S. Cl. CPC G06F 9/5027; G06N 3/092

(57) ABSTRACT

The technologies described herein are generally directed to computational task placement using a predictive model. For instance, a system can, based on task information, identify a task allocation plan including a first potential resource allocation for performance of the task and a second potential resource allocation for the performance of the task, with the first potential resource allocation and the second potential resource allocation including respective task performance predictions. The system may further generate respective confidence scores for the respective performance predictions. Further, the system may, based on a confidence score of the respective confidence scores of the first potential resource allocation, allocate, in accordance with the first potential resource allocation, a resource for the performance of the task, resulting in a resource allocation, with the resource allocation including the confidence score of the first potential resource allocation.

### BACKGROUND

Modern approaches to selecting combinations of computer resources to perform computational tasks may utilize static approaches where tasks are assigned to be performed by devices based on rules or manual selection. In some circumstances, heterogeneous systems with varying workloads and hardware capabilities may increase the complexity of device placement.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, based on task information corresponding to a task, identifying, by a computing system comprising one or more processors, a task allocation plan comprising a first potential resource allocation for performance of the task and a second potential resource allocation for the performance of the task, with the first potential resource allocation and the second potential resource allocation including respective performance predictions for the performance of the task. The method may further include generating, by the computing system, respective confidence scores for the respective performance predictions. Further, the method may include, based on a confidence score of the respective confidence scores of the first potential resource allocation, allocating, by the computing system in accordance with the first potential resource allocation, a resource of available resources for the performance of the task, resulting in a resource allocation, with the resource allocation including the confidence score of the first potential resource allocation.

Additionally or alternatively, based on a model of operation of the available resources, applying, by the computing system, conformal prediction to the first potential resource allocation, with the applying of the conformal prediction including generating the confidence score of the first potential resource allocation. Additionally or alternatively, the task allocation plan was generated based on the task information and a reinforcement learning model trained based on historical information comprising normal events and abnormal events applicable to tasks allocated to the available resources.

Additionally or alternatively, based on the task information, a performance characteristic of the resource, and results of the performance of the task, updating, by the computing system, the reinforcement learning model, with the results including a measurement of the performance characteristic of the resource collected from performance of the task. Additionally or alternatively, the reinforcement learning model was trained based on historical and real-time performance data from the available resources, applicable to performance of the task, comprising performance data applicable to at least one of an input size of the task, an output size of the task, and operations performed during the performance of the task.

Additionally or alternatively, the confidence score includes a first confidence score, the resource allocation includes a first resource allocation, the resource includes a first resource, and the method further includes, based on monitoring the performance of the task, updating, by the computing system, the first confidence score. Additionally or alternatively, based on a change in the first confidence score and a second confidence score based on a second confidence score of the respective confidence scores of the second potential resource allocation, employing, by the computing system, the second potential resource allocation as a second resource allocation, to allocate a second resource for continuing the performance of the task. Additionally or alternatively, the change in the first confidence score includes a change in the first confidence score to being below a confidence threshold.

Additionally or alternatively, the confidence threshold was determined based on a criticality of the task and a likelihood of uncertainty applicable to the generating of the respective confidence scores. Additionally or alternatively, the confidence score includes a first confidence score, and further including, based on a difference between the first confidence score of the first potential resource allocation and a second confidence score of the second potential resource allocation, identifying a third resource allocation applicable to the task allocation plan.

Additionally or alternatively, the identifying of the third resource allocation was based on the difference indicating an uncertainty level above an uncertainty threshold. Additionally or alternatively, a result of the monitoring of the performance of the task includes at least one of a measurement of a device load of the first resource, inter-device communication volume between the first resource and other resources other than the first resource, available memory of the first resource, and an available compute capacity of the first resource. Additionally or alternatively, the respective performance predictions include at least one of, a prediction of a runtime of the performance of the task, memory usage for the performance of the task, and a compute total for the performance of the task.

Additionally or alternatively, the task information includes first task information, with the task includes a first task, the respective performance predictions include a first performance prediction applicable to the first potential resource allocation and a second performance prediction applicable to the second potential resource allocation, the task allocation plan includes a first task allocation plan. Additionally or alternatively, the method further includes, based on second task information corresponding to a second task, identifying a second task allocation plan comprising a third potential resource allocation for performance of the second task and a fourth potential resource allocation for the performance of the second task, the third potential resource allocation includes a third performance prediction for the performance of the second task based on the third potential resource allocation and the fourth potential resource allocation, and the fourth potential resource allocation includes a fourth performance prediction for the performance of the second task based on the third potential resource allocation and the fourth potential resource allocation. Additionally or alternatively, the method further includes, generating a directed acyclic graph comprising the first task information, the second task information, and a relationship between the first task information and the second task information.

An example system can operate as follows. At least one memory may store computer executable instructions, and at least one processor may be configured to process the computer executable instructions that, when executed by the at least one processor, facilitate performance of operations. The operations may include receiving a request for a mapping of a task to computing equipment in a cloud-based computer network. The operations may further include, based on task information describing the task and a state of the computing equipment, sampling a reinforcement learning model, resulting in the mapping of the task comprising the mapping of the task to a resource of the computing equipment, and the reinforcement learning model, was trained based on performance data describing a performance of tasks by the computing equipment, and employs conformal prediction to the mapping of the task, resulting in the mapping of the task comprising a confidence score applicable to results of the mapping of the task. The operations may further include updating the reinforcement learning model based on the results, the mapping of the task, and the confidence score.

Additionally or alternatively, the performance data is applicable to at least one of an input size of a prior task performed by the computing equipment, an output size of the prior task performed by the computing equipment, and an operation performed during performance of the prior task by the computing equipment. Additionally or alternatively, the resource includes a first resource, and the mapping of the task includes a first mapping of the task, and the operations further include, during performance of the task using the first resource, receiving an indication that the performance of the task using the first resource has decreased below a threshold level of performance, communicating a fallback plan for the performance of the task, including a second mapping of the task to a second resource of the computing equipment, with the updating of the reinforcement learning model based on the results including updating the reinforcement learning model further based on the indication that the performance by the first resource decreased below the threshold level of performance, and the fallback plan.

An example non-transitory machine-readable medium may include executable instructions that, when executed by at least one processor, facilitate performance of operations. The operations may include receiving, from machine learning equipment, at least two initial placement specifications for performance of a computational task by resources of a distributed computer system. The operations may further include, based on conformal prediction model, generating respective likelihood scores for the performance of the computational task in accordance with the at least two initial placement specifications. The operations may further include, based on a result of comparing the respective likelihood scores, selecting an implemented initial placement specification from the at least two placement specifications. The operations may further include communicating, to the machine learning equipment, the implemented initial placement specification, a likelihood score of the respective likelihood scores of the implemented initial placement specification, and a measure of a result of the implemented initial placement specification.

Additionally or alternatively, the generating of the respective likelihood scores includes generating a directed acyclic data structure comprising the at least two initial placement specifications, a relationship between the at least two initial placement specifications, and the respective likelihood scores, and with the operations further including communicating the directed acyclic data structure to the machine learning equipment. Additionally or alternatively, nodes of the directed acyclic data structure include operation identifiers applicable to the computational task, wherein the operation identifiers include at least one of a matrix multiplication identifier, a convolution identifier, and an activation identifier. Additionally or alternatively, edges of the directed acyclic data structure include dependencies between the nodes, and the dependencies include at least one of an indication of data flow between the nodes, and an indication of an execution order of operations corresponding to the nodes.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate computational task placement using task allocation equipment and modeling equipment, in accordance with one or more embodiments;

FIG. 2 is an architecture diagram of an example system that can facilitate computational task placement, in accordance with one or more embodiments;

FIG. 3 includes a diagram that illustrates aspects of example system that can summarize one or more combinations of processes described herein that facilitate computational task placement, in accordance with one or more embodiments;

FIG. 4 includes a diagram that illustrates aspects of example system that can collect and prepare task and system data to facilitate computational task placement, in accordance with one or more embodiments;

FIG. 5 includes a diagram that illustrates aspects of example system that can generate task placement plans by sampling a machine learning model, in accordance with one or more embodiments;

FIG. 6 includes example tables illustrate aspects of example system that can facilitate computational task placement by evaluating the reliability of generated placement plans, in accordance with one or more embodiments;

FIG. 7 includes a diagram that illustrates aspects of example system that can facilitate computational task placement by evaluating the reliability of generated placement plans, in accordance with one or more embodiments;

FIG. 8 includes a diagram that illustrates aspects of example system that can facilitate computational task placement, in accordance with one or more embodiments;

FIG. 9 includes a diagram that illustrates aspects of example system that can facilitate computational task placement, in accordance with one or more embodiments;

FIG. 10 depicts a flow diagram representing example operations of an example method that can facilitate computational task placement, in accordance with one or more embodiments;

FIG. 11 depicts an example system that can facilitate computational task placement, in accordance with one or more embodiments;

FIG. 12 depicts an example non-transitory machine-readable medium that can include executable instructions that, when executed by a processor of a system, can facilitate computational task placement, in accordance with one or more embodiments;

FIG. 13 is a schematic block diagram of a system with which the disclosed subject matter can interact; and

FIG. 14 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of systems with concurrent reading and writing processes can be improved, e.g., by providing approaches that combine adaptive learning with uncertainty quantification. Technological problems solved by technical solutions described herein include, but are not limited to, problems in modern distributed computing environments, e.g., dynamic workloads, hardware variability, and inefficient resource utilization. For example, in dynamic and non-stationary environments, static placement decisions can lead to resource bottlenecks, increased latencies, and inefficiencies.

One or more embodiments described herein are not abstract concepts; rather, they provide technical solutions to technical problems. For example, as described herein embodiments include mechanisms to dynamically reassign tasks or adjust placements in real time based on observed performance metrics. Embodiments may enable a distributed compute model where decision-making may be dynamically shared between the cloud and client resources, providing results that include ensuring intelligent allocation of workloads across heterogeneous devices, minimizing redundancy and over-provisioning while enabling effective workload sharing. Additionally, end-user experiences may be improved by localizing latency-sensitive tasks to edge devices and offloading less critical workloads to the cloud, e.g., by reducing latency, embodiments may improve runtime performance, and enhance thermal efficiency. Moreover, implementations described herein can rapidly and dynamically provide these solutions in a manner that cannot reliably be performed by a human or even a plurality of humans.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments a related to device placement technologies. Some implementations may integrate adaptive learning and uncertainty quantification to provide a foundation for reliable and efficient execution of large-scale computational graphs in dynamic environments.

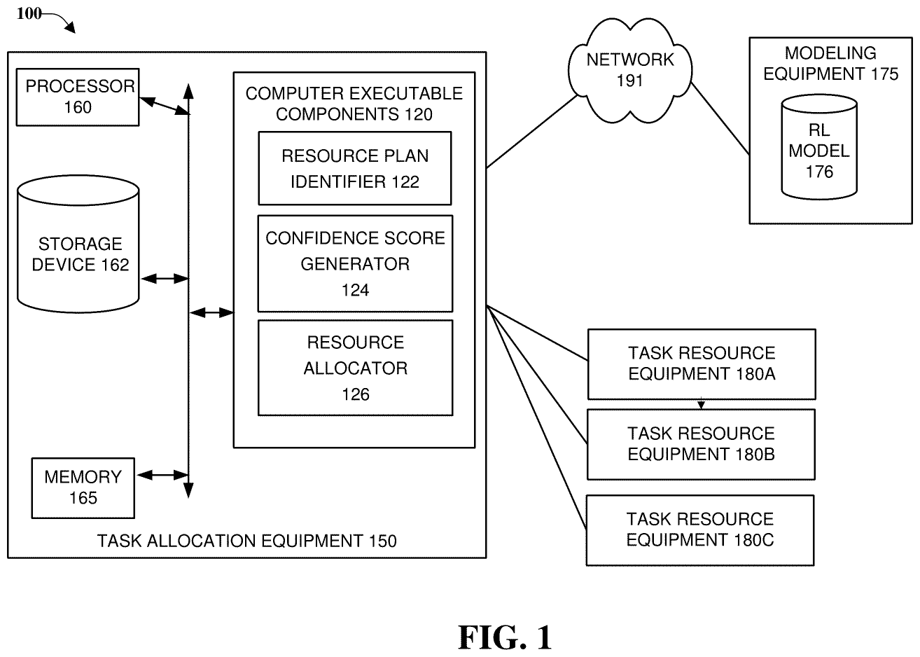

FIG. 1 is an architecture diagram of an example system 100 that can facilitate computational task placement using task allocation equipment and modeling equipment, in accordance with one or more embodiments. For purposes of brevity, description of like elements and/or processes employed in other embodiments is omitted. As depicted, system 100 includes task allocation equipment 150 connected, via network 191, to modeling equipment 175, and task resource equipment 180A-C.

As depicted, task allocation equipment 150 can include memory 165 that can store one or more computer and/or machine readable, writable, and/or executable components 120 and/or instructions. In embodiments, task allocation equipment 150 can further include processor 160. In one or more embodiments, computer executable components 120, when executed by processor 160, can facilitate performance of operations defined by the executable component(s) and/or instruction(s). Computer executable components 120 can include resource plan identifier 122, confidence score generator 124, resource allocator 126, and other components described or suggested by different embodiments described herein, that can improve the operation of system 100. Task allocation equipment 150 may further include storage device 162. In an example, storage device 162 may provide nonvolatile storage of data, data structures, computer executable instructions, and so forth.

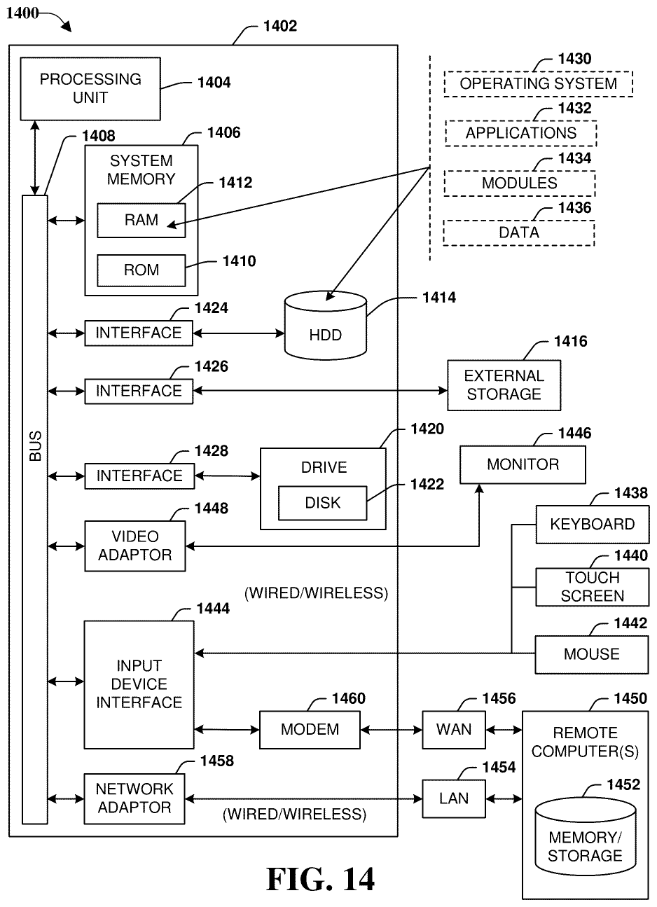

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1404 of FIG. 14. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1406 and FIG. 14. Such examples of memory 165 can be employed to implement any embodiments of the subject disclosure.

As described herein, example embodiments may a select computational devices to perform combinations of tasks by automating the collection of observed metrics using monitoring tools integrated with the system's execution environment, using a reward adjustment mechanism within a reinforcement learning model to incorporate error penalties dynamically, regularly retrain the reinforcement learning model and recalibrate the conformal prediction module based on updated data, and schedule feedback cycles to occur after each task execution batch to maintain model accuracy.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of resource plan identifier 122, which can in some implementations may identify a task allocation plan comprising a first potential resource allocation for performance of the task and a second potential resource allocation for the performance of the task, with the first potential resource allocation and the second potential resource allocation including respective performance predictions for the performance of the task. For example, in one or more embodiments, resource plan identifier 122 may identify a task allocation plan that includes a first potential resource allocation of task resource equipment 180A and a second potential resource allocation of task resource equipment 180B, with the first potential resource allocation and the second potential resource allocation including respective performance predictions for the performance of the task, e.g., generated by sampling reinforcement learning model 176, hosted by modeling equipment 175.

In another example, memory 165 can store executable instructions that can facilitate generation of confidence score generator 124, which in some implementations may generate respective confidence scores for the respective performance predictions. For example, in one or more embodiments, confidence score generator 124 can generate respective confidence scores for the respective performance predictions of task performance by task resource equipment 180A-B.

In another example, memory 165 can store executable instructions that can facilitate generation of resource allocator 126, which in some implementations may, based on a confidence score of the respective confidence scores of the first potential resource allocation, allocate, in accordance with the first potential resource allocation, a resource of available resources for the performance of the task, resulting in a resource allocation, with the resource allocation including the confidence score of the first potential resource allocation. For example, in one or more embodiments, resource allocator 126 may, based on a confidence score of the respective confidence scores of the first potential resource allocation, allocate, in accordance with the first potential resource allocation, task resource equipment 180A for the performance of the task, resulting in a resource allocation, with the resource allocation including the confidence score of the first potential resource allocation.

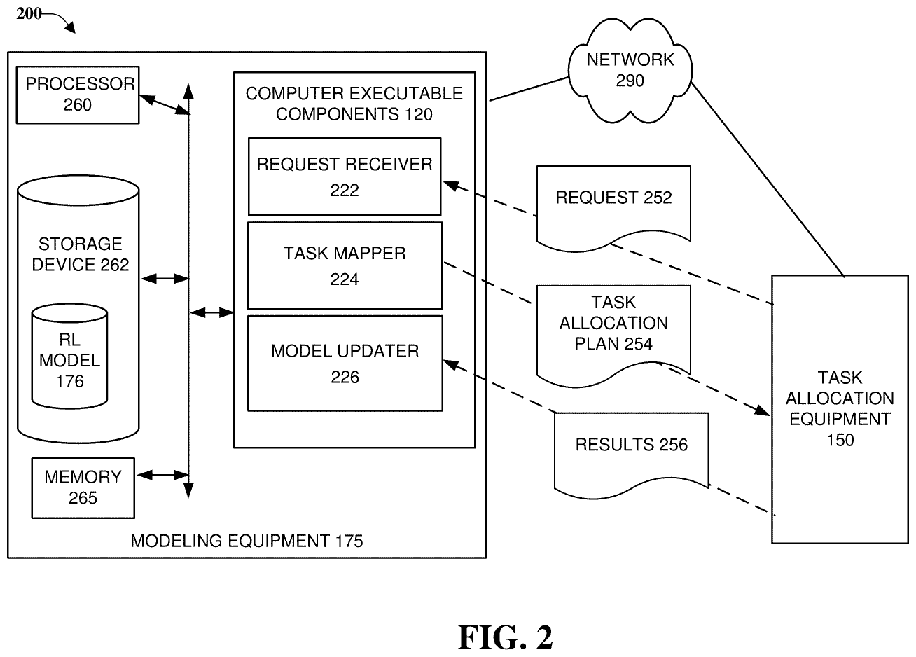

FIG. 2 is an architecture diagram of an example system 200 that can facilitate computational task placement, in accordance with one or more embodiments. For purposes of brevity, description of like elements and/or processes employed in other embodiments is omitted. As depicted, system 200 includes modeling equipment 175 connected, via network 290, to task allocation equipment 150. Modeling equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include request receiver 222, task mapper 224, model updater 226, and other components described or suggested by different embodiments described herein, e.g., that can improve the operation of system 200, in accordance with one or more embodiments.

As discussed further with FIG. 14 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of modeling equipment 175, memory 265 can store executable instructions that can facilitate generation of request receiver 222, which in some implementations, may receive a request for a mapping of a task to computing equipment in a cloud-based computer network. For example, one or more embodiments, request receiver 222 may receive request 232 for a mapping of a task to one or more of task resource equipment 180A-C.

In an example implementation of modeling equipment 175, memory 265 can further store executable instructions that can facilitate generation of task mapper 224, which in some implementations, may, based on task information describing the task and a state of the computing equipment, sample a reinforcement learning model, resulting in the mapping of the task comprising the mapping of the task to a resource of the computing equipment, and the reinforcement learning model, was trained based on performance data describing a performance of tasks by the computing equipment, and employs conformal prediction to the mapping of the task, resulting in the mapping of the task comprising a confidence score applicable to results of the mapping of the task. For example, in one or more embodiments, task mapper 224 may, based on task information received with request 232, sample reinforcement learning model 176, resulting in task allocation plan 254. In an example, reinforcement learning model 176, was trained based on past results 256, e.g., based on performance data describing a performance of tasks by one or more of task resource equipment 180A-C.

In an example implementation of modeling equipment 175, memory 265 can further store executable instructions that can facilitate generation of model updater 226, which in some implementations, may update the reinforcement learning model based on the results, the mapping of the task, and the confidence score. For example, in one or more embodiments, model updater 226 may update reinforcement learning model 176 based on results 256, the mapping of the task to one or more of task resource equipment 180A-C, and the confidence score, e.g., generated by confidence score generator 124.

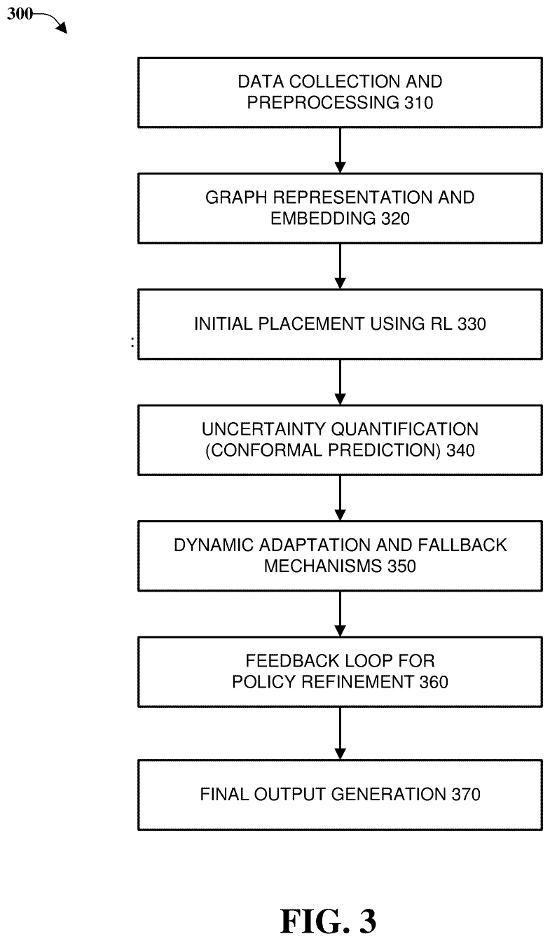

FIG. 3 includes a diagram that illustrates aspects of example system 300 that can summarize one or more combinations of processes described herein that facilitate computational task placement, in accordance with one or more embodiments. For purposes of brevity, description of like elements and/or processes employed in other embodiments is omitted.

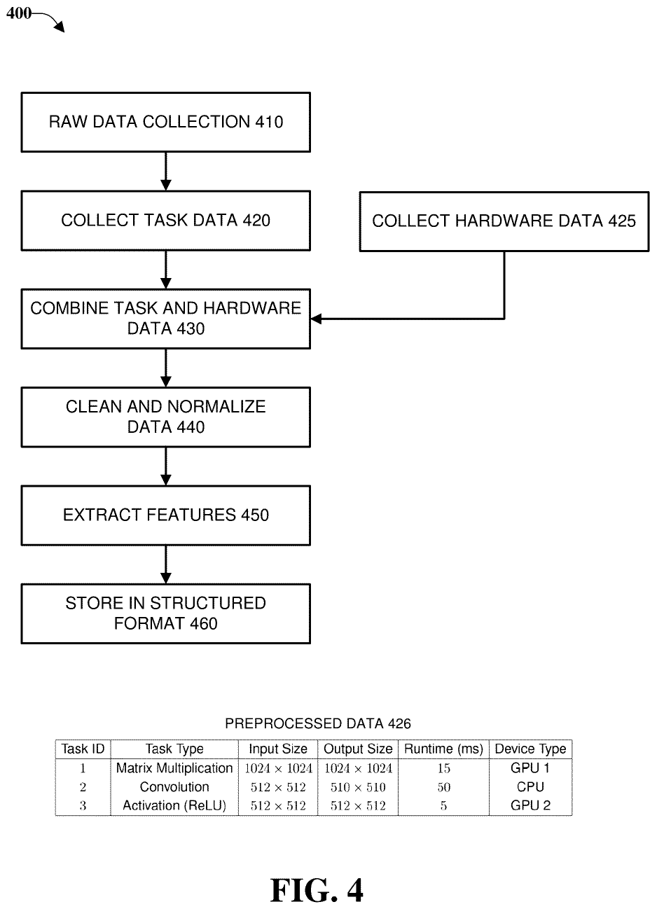

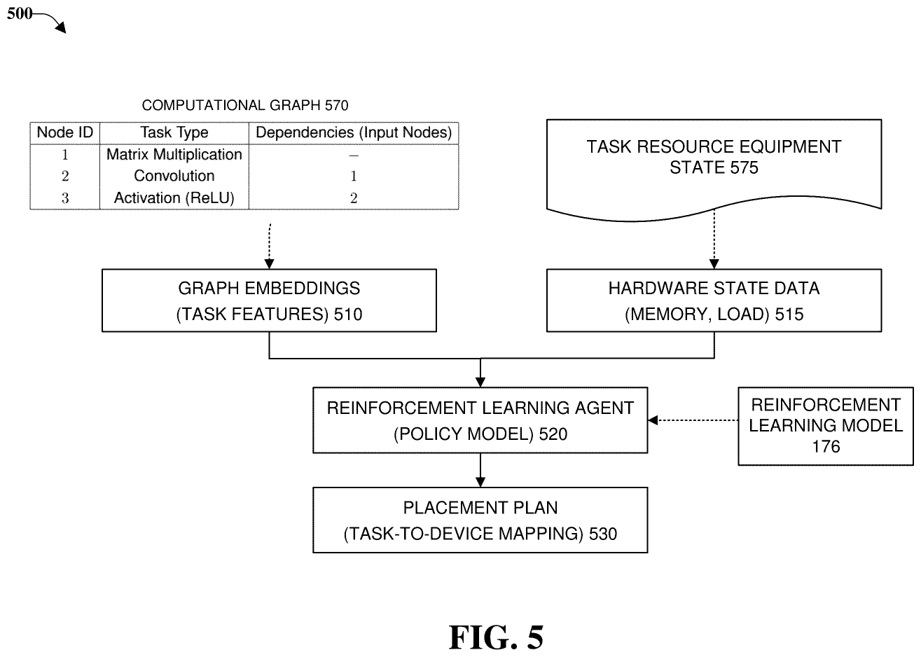

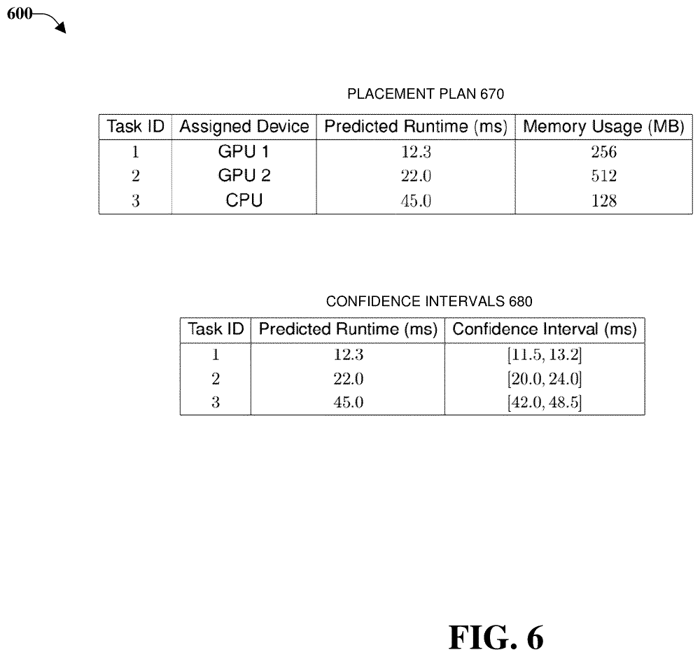

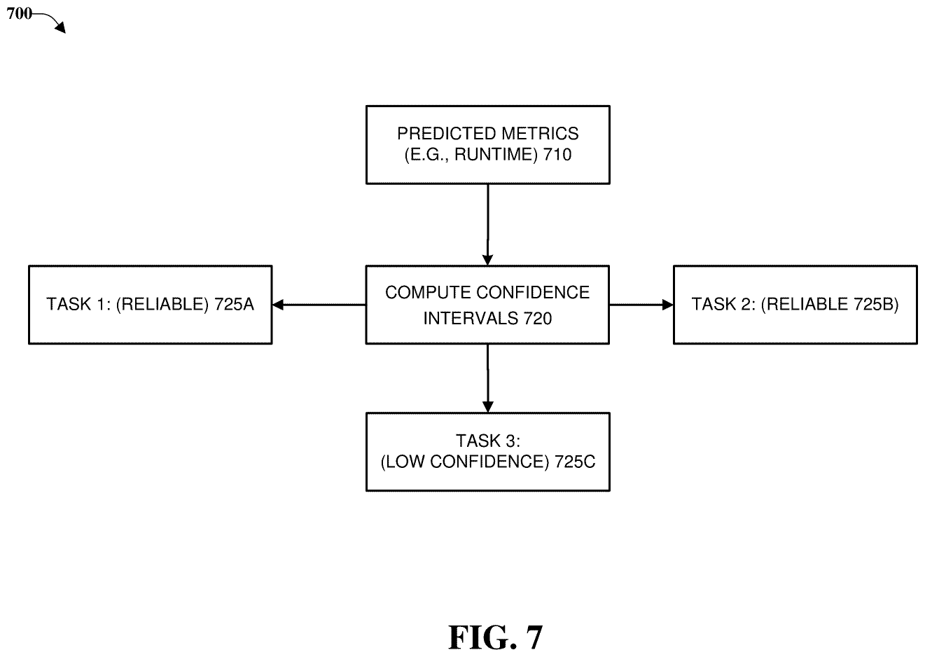

At 310, as discussed with FIG. 4, data may be collected and preprocessed to provide a structured foundation for subsequent computational graph analysis and task placement. At 320, as discussed with FIG. 4, the computational tasks may be represented as a graph that captures task relationships and dependencies. At 330, as discussed with FIG. 5, for a particular combination of tasks, reinforcement learning model 176 may be used to create an initial mapping of the computational tasks to available devices. At 340, as discussed with FIGS. 6-7, the reliability of the initial placement plan generated by 330 may be evaluated by applying conformal prediction, e.g., facilitating the identification and flagging low-confidence assignments for further review.

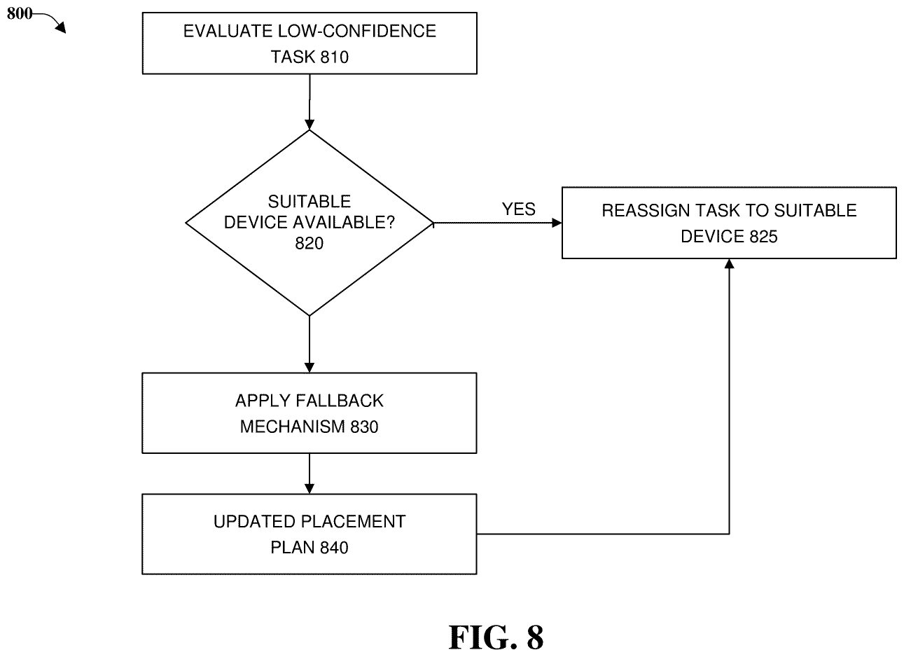

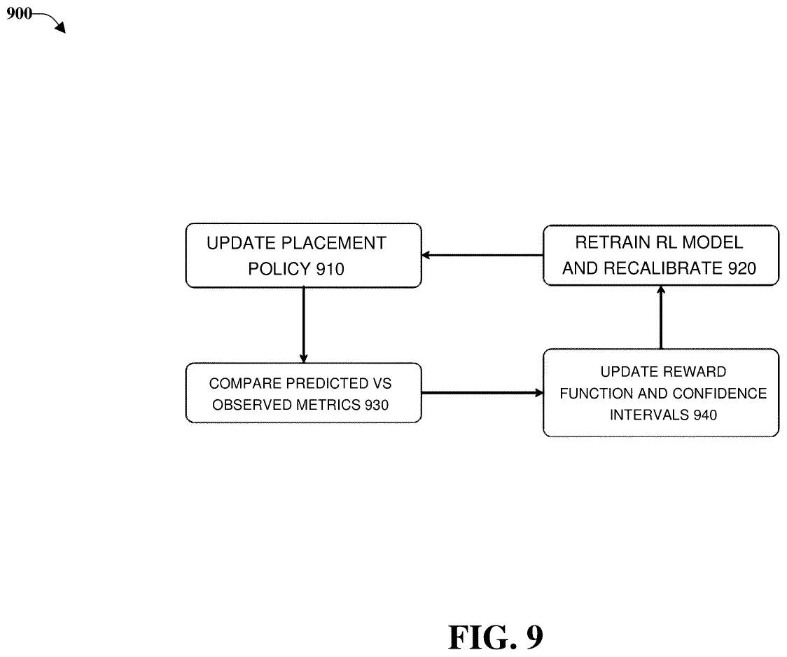

At 350, as discussed with FIG. 8, tasks flagged as low confidence may be dynamically reassigned or adjusted to maintain the reliability and efficiency of the system. By leveraging real-time hardware metrics and fallback strategies, embodiments may adapt placements to changing conditions. At 360, as discussed with FIG. 9, a feedback loop may be used by embodiments to continuously improve the task placement policies of the system by analyzing discrepancies between predicted and observed performance metrics, e.g., using this feedback to refine both the reinforcement learning model and uncertainty quantification by a conformal prediction model. At 370, as discussed with FIG. 9, refined decisions and outputs may be consolidated into comprehensive task-to-device placement plans, e.g., including detailed mappings, performance predictions, and confidence metrics.

FIG. 4 includes a diagram that illustrates aspects of example system 400 that can collect and prepare task and system data to facilitate computational task placement, in accordance with one or more embodiments. For purposes of brevity, description of like elements and/or processes employed in other embodiments is omitted.

At 410, one or more embodiments may gather historical and real-time performance data from the system. Embodiments collect data from the past performance of different tasks by system resources, e.g., task resource equipment 180A-C. At 420, task data is collected. Example historical task performance data include task type (e.g., matrix multiplication, convolution) and details about device performance, e.g., device type, runtime of task, memory used, and inter-device communication costs. At 425, hardware data is collected describing operational characteristics of task resource equipment 180A-C. At 430, collected task data 420 and collected hardware data 425 are combined, then at 440, cleaned and normalized, e.g., to remove outliers and ensure consistency. At 450, feature engineering 450 may be applied to encode additional attributes, such as adjacency relationships.

At 460, collected and preprocessed data may be stored in a structured format. that captures task relationships and dependencies. In an example implementation, example preprocessed data 426 includes task ID, task type, input size, output size, runtime, and device type.

FIG. 5 includes a diagram that illustrates aspects of example system 500 that can generate task placement plans by sampling a machine learning model, in accordance with one or more embodiments. For purposes of brevity, description of like elements and/or processes employed in other embodiments is omitted. System 500 includes graph embeddings 510 with an example computational graph 570, and hardware state data 515 includes an example task resource equipment state 575.

In some implementations, to facilitate use of reinforcement learning agent 520, the computational tasks to be placed may be represented as a computational graph 570, e.g., embedding preprocessed data 426 into a feature-rich space that can capture task relationships and dependencies. An example computational graph that may be used by one or more embodiments is a directed acyclic graph, where nodes represent tasks (e.g., matrix multiplication or convolution), and edges represent dependencies between tasks, indicating data flow or execution order. In implementations the directed acyclic graph may be embedded into a high-dimensional feature space to capture both node attributes (e.g., runtime, memory usage) and structural properties (e.g., adjacency relationships). In one or more embodiments, graph embedding techniques like graph neural networks may be utilized to generate the directed acyclic graph.

Computational graph 570 provides an example of the encoding of task dependencies and characteristics into a numerical format, e.g., to improve the efficiency of analysis of the graph. For example, in Computational graph 570, the embedding of task 1 reflects its independence from other tasks, while the embedding of task 3 incorporates a dependency on the performance of task 2.

At 520, a reinforcement learning agent may be used to interface with reinforcement learning model 176. In one or more embodiments, reinforcement learning may be used to create an initial mapping of computational tasks to task resource equipment 180A-C. This placement plan may be used by different approaches detailed with FIGS. 6-9 below.

In one or more embodiments, a reinforcement learning agent may operate in an environment defined by: a state, an action, and a reward. In an example, the state used by the reinforcement learning agent to sample reinforcement learning model 176 includes graph embeddings of computational graph 570 combined with hardware state data 515, e.g., device load, and memory availability.

In an example, the action sampled from reinforcement learning model 176 includes assigning a specific task (e.g., node in computational graph 570) to a particular device (e.g., graphics processing unit (GPU) 1, central processing unit (CPU)). In an example, the reward sampled from reinforcement learning model 176 includes a function designed to minimize runtime and communication costs while improving performance and resource utilization.

FIG. 6-7 includes example tables and a diagram that illustrates aspects of example systems 600 and 700 that can facilitate computational task placement by evaluating the reliability of generated placement plans, in accordance with one or more embodiments. For purposes of brevity, description of like elements and/or processes employed in other embodiments is omitted. System 600 includes placement plan 670 and confidence intervals 680. System 700 includes tasks 725A-C, computed confidence intervals 720 based on predicted runtime metrics 710.

One or more embodiments may evaluate the initial placement plan of 530, and iteratively change the placements based on interactions with the environment. Placement plan 670 is an example of predicted metrics that may be used by embodiments, e.g., either an initial placement plan as discussed above or an iterative revision of a placement plan. In one or more embodiments, at 720, a confidence interval may be determined for the predicted runtimes, e.g., generating confidence intervals 680 for the tasks of computational graph 570 included within the initial placement plan 670. In an implementation, the reliability of the initial placement plan may be evaluated by applying conformal prediction. At 720, confidence intervals may be computed for each placement decision, e.g., confidence intervals 680 generated for task IDs 1-3 of placement plan 670.

In one or more embodiments, the generated confidence intervals may incorporate the uncertainty of predictions into the decision-making process, e.g., enabling embodiments to identify and flag low-confidence assignments for further review before task placement selections occur. In the example confidence intervals 680. Task 1 (725A) may be evaluated as reliable with a narrow interval of [11.5, 13.2], e.g., according to a threshold level of reliability. In contrast, task 3 (725C) may be flagged for reassignment due to a wider interval of [42.0, 48.5], e.g., lower reliability than the prediction for task 1, and below the threshold level of reliability.

In an embodiment, the confidence intervals of 720 may be used to guide dynamic adaptations of task placements described with FIG. 8 below.

FIG. 8 includes a diagram that illustrates aspects of example system 800 that can facilitate computational task placement, in accordance with one or more embodiments. For purposes of brevity, description of like elements and/or processes employed in other embodiments is omitted.

In an implementation, at 810, tasks flagged as low confidence at 720 may be dynamically reassigned or adjusted to improve the reliability and/or efficiency of the system. One or more embodiments may, by leveraging real-time hardware metrics potentially triggering fallback strategies, adapt placements to changing conditions. One approach used to evaluate low-confidence tasks 810 includes, but is not limited to analyzing real-time hardware statistics of task resource equipment 180A-C, including device load, available memory, and compute capacity. To label tasks with low confidence of being performed according to predictions, a threshold for acceptable confidence interval width, e.g., as discussed with task 3 (725C) above. For instance, if the width exceeds 5 ms, the placement may be flagged for reassessment.

At 820, hardware statistics may be used to identify an alternative device with sufficient capacity handle a reassignment with improved results. When a suitable device is identified, at 825, the task may be reassigned thereto. When no suitable device is available for reassignment, at 830, fallback strategies are employed. An example fallback strategy that may be employed by one or more embodiments includes dividing the task into smaller subtasks that can be distributed across multiple devices, e.g., changing the definition of a suitable device to include devices that can share subtasks. In another fallback strategy, one or more embodiments may delay non-critical tasks to allocate resources to high-priority operations. In another fallback strategy, one or more embodiments may redistribute memory or compute power between tasks on the same device. In an example, at 840, an updated placement plan may be generated that incorporated one or more fallback strategies.

FIG. 9 includes a diagram that illustrates aspects of example system 900 that can facilitate computational task placement, in accordance with one or more embodiments. For purposes of brevity, description of like elements and/or processes employed in other embodiments is omitted. System 900 includes an example feedback look that may be used to continuously improve the task placement policies of embodiments, e.g., by analyzing discrepancies between predicted and observed performance metrics.

At 930, gathered real-time execution metrics may be compared to the predicted values, and a discrepancy may be determined for tasks. In an example, this discrepancy may be determined as follows: Discrepancy=|Observed Runtime−Predicted Runtime|. At 940, in an implementation, a reward function of reinforcement learning model 176 (e.g., used at 520) may be altered, e.g., to penalize relatively high-discrepancy placements: Updated Reward=original reward−λ*discrepancy, with λ corresponding to a scaling factor that may be used to control the weight of the penalty.

At 920, reinforcement learning model 176 may be retrained based on the updated reward. In addition to modifying the reward function, at 920 the above approach may also be used to recalibrate the conformal prediction model based on the discrepancy into, e.g., to improve the accuracy of future predictions. Returning to the example of confidence intervals 680, for task 2 (725B) with a 1.8 ms error, the placement of task 2 may be redefined at 910, and these results may be incorporated into the reinforcement learning model, and conformal prediction model, e.g., to facilitate the generation by embodiments, of more reliable decisions in dynamic environments.

In one or more embodiments, refined decisions and outputs may be incorporated into a comprehensive task-to-device placement plan. This plan may include one or more of, detailed mappings, performance predictions, and confidence metrics. This integrated plan may facilitate the validation of device assignments based on performance thresholds, and well as verifying that task placements do not exceed different resource capacities, e.g., memory, compute power. Returning to the example of task 3 (725C), the example confidence interval width (6.5 ms) exceeds an example threshold (5 ms). In this example, task 3 (725C) may be reassigned to GPU 2, thereby reducing the runtime variability and improving overall system performance.

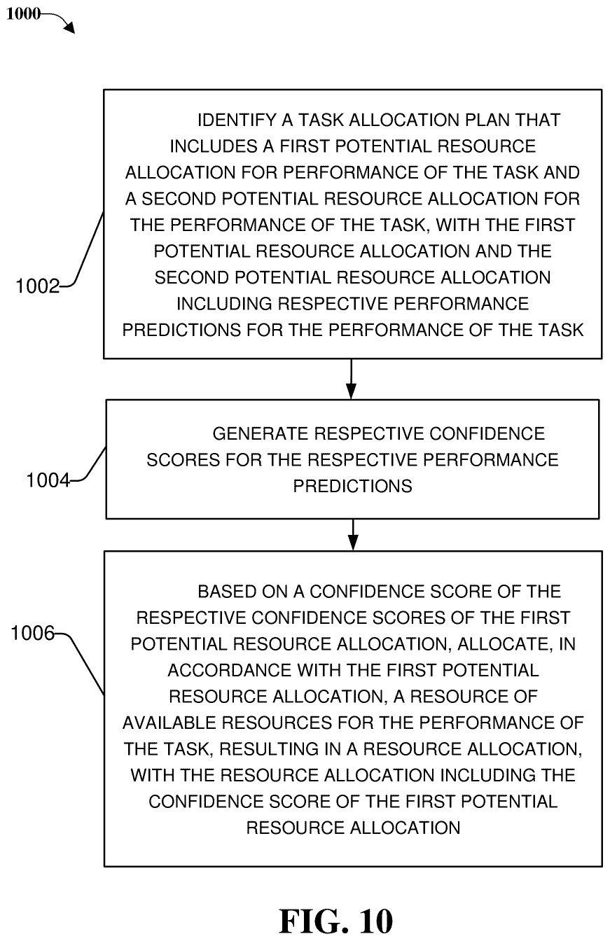

FIG. 10 depicts a flow diagram representing example operations of an example method 1000 that can facilitate computational task placement, in accordance with one or more embodiments. For purposes of brevity, description of like elements and/or processes employed in other embodiments is omitted.

In some examples, one or more embodiments of method 1000 can be implemented by resource plan identifier 122, confidence score generator 124, resource allocator 126, and other components that can be used to implement aspects of method 1000, in accordance with one or more embodiments. FIG. 10, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 1002 of method 1000, resource plan identifier 122 of task allocation equipment 150 can identify a task allocation plan that includes a first potential resource allocation for performance of the task and a second potential resource allocation for the performance of the task, with the first potential resource allocation and the second potential resource allocation including respective performance predictions for the performance of the task. At 1004 of method 1000, confidence score generator 124 can generate respective confidence scores for the respective performance predictions. At 1006 of method 1000, resource allocator 126 can, based on a confidence score of the respective confidence scores of the first potential resource allocation, allocate, in accordance with the first potential resource allocation, a resource of available resources for the performance of the task, resulting in a resource allocation, with the resource allocation including the confidence score of the first potential resource allocation.

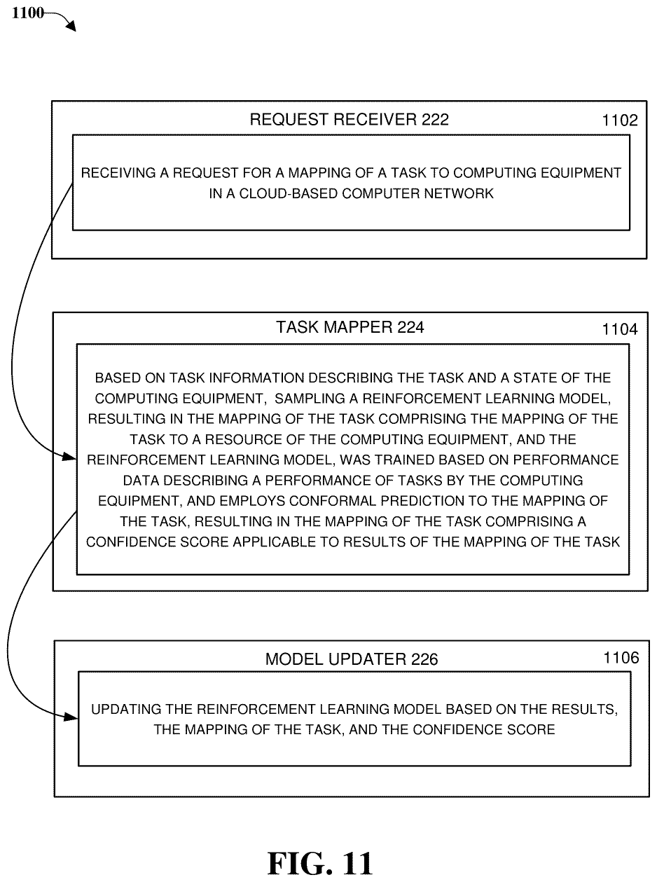

FIG. 11 depicts an example system 1100 that can facilitate computational task placement, in accordance with one or more embodiments. For purposes of brevity, description of like elements and/or processes employed in other embodiments is omitted.

System 1100 includes at least one memory that stores computer executable components, and at least one processor that executes the computer executable components stored in the at least one memory, with the computer executable components including request receiver 222, task mapper 224, model updater 226, and other components that can be used to implement aspects of system 1100, as described herein, in accordance with one or more embodiments.

At 1102 of FIG. 11, request receiver 222 can receive a request for a mapping of a task to computing equipment in a cloud-based computer network. At 1104 of FIG. 11, task mapper 224 can, based on task information describing the task and a state of the computing equipment, sample a reinforcement learning model, resulting in the mapping of the task comprising the mapping of the task to a resource of the computing equipment, and the reinforcement learning model, was trained based on performance data describing a performance of tasks by the computing equipment, and employs conformal prediction to the mapping of the task, resulting in the mapping of the task comprising a confidence score applicable to results of the mapping of the task. At 1106 of FIG. 11, model updater 226 can update the reinforcement learning model based on the results, the mapping of the task, and the confidence score.

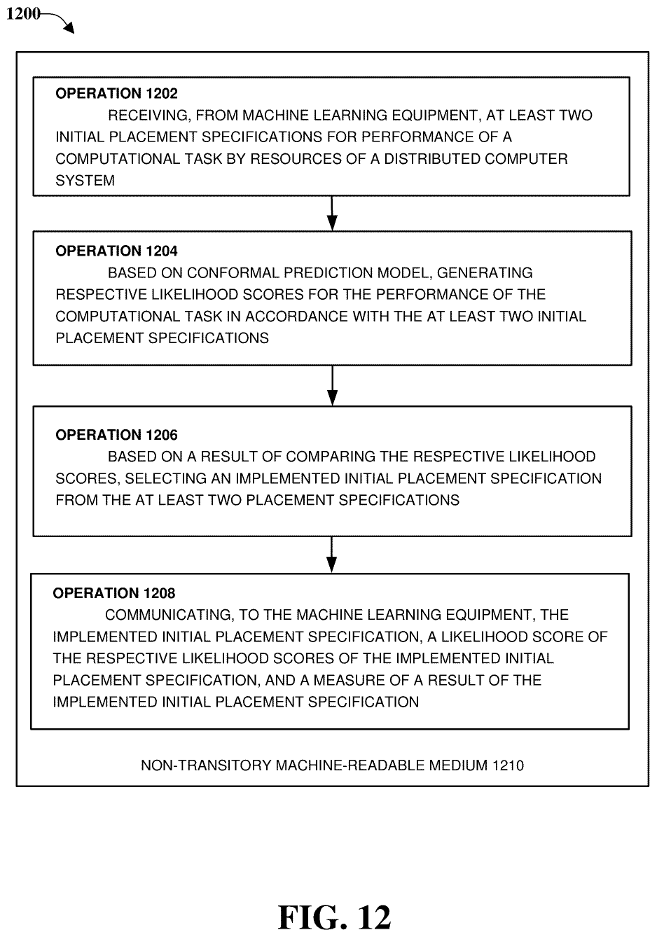

FIG. 12 depicts an example 1200 non-transitory machine-readable medium 1210 that can include executable instructions that, when executed by a processor of a system, can facilitate computational task placement, in accordance with one or more embodiments. For purposes of brevity, description of like elements and/or processes employed in other embodiments is omitted.

As depicted, non-transitory machine-readable medium 1210 includes executable instructions that, when executed by at least one processor of a machine learning device, facilitate performance of operations that include operation 1202 which can receive, from machine learning equipment, at least two initial placement specifications for performance of a computational task by resources of a distributed computer system. The operations may further include operation 1204 which can, based on conformal prediction model, generate respective likelihood scores for the performance of the computational task in accordance with the at least two initial placement specifications.

The operations may further include operation 1206 which can, based on a result of comparing the respective likelihood scores, selecting an implemented initial placement specification from the at least two placement specifications. The operations may further include operation 1208 which can communicate, to the machine learning equipment, the implemented initial placement specification, a likelihood score of the respective likelihood scores of the implemented initial placement specification, and a measure of a result of the implemented initial placement specification.

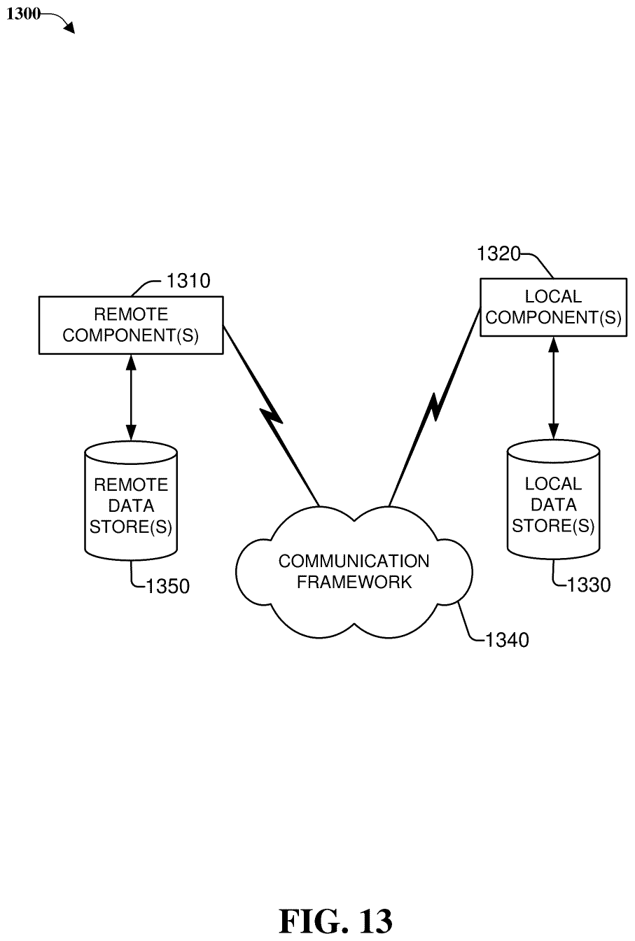

FIG. 13 is a schematic block diagram of a system 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, RAN devices, gateway devices, femtocell devices, servers, etc. The system 1300 also comprises one or more local component(s) 1320. The local component(s) 1320 can be hardware and/or software (e.g., threads, processes, computing devices).

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1320 (see below), non-volatile memory 1322 (see below), disk storage 1324 (see below), and memory storage, e.g., local data store(s) 1330 and remote data store(s) 1350, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random-access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some, if not all aspects of the subject disclosure can be practiced on stand-alone computers. In a distributed computing environment, program modules can be located in different systems, e.g., both local and remote memory storage devices.

Referring now to FIG. 14, in order to provide additional context for various embodiments described herein, FIG. 14 and the following discussion are intended to provide a brief, general description of a suitable computing environment 1400 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid-state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1494 interface technologies. Other external drive connection technologies are within contemplation of the embodiments described herein.

The drives and their associated computer-readable storage media provide nonvolatile storage of data, data structures, computer executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1494 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on task information corresponding to a task, identifying, by a computing system comprising one or more processors, a task allocation plan comprising a first potential resource allocation for performance of the task and a second potential resource allocation for the performance of the task, wherein the first potential resource allocation and the second potential resource allocation comprise respective performance predictions for the performance of the task;
generating, by the computing system, respective confidence scores for the respective performance predictions; and
based on a confidence score of the respective confidence scores of the first potential resource allocation, allocating, by the computing system in accordance with the first potential resource allocation, a resource of available resources for the performance of the task, resulting in a resource allocation, wherein the resource allocation comprises the confidence score of the first potential resource allocation.

2. The method of claim 1, further comprising:
based on a model of operation of the available resources, applying, by the computing system, conformal prediction to the first potential resource allocation, wherein the applying of the conformal prediction comprises generating the confidence score of the first potential resource allocation.

3. The method of claim 1, wherein the task allocation plan was generated based on the task information and a reinforcement learning model trained based on historical information comprising normal events and abnormal events applicable to tasks allocated to the available resources.

4. The method of claim 3, further comprising:
based on the task information, a performance characteristic of the resource, and results of the performance of the task, updating, by the computing system, the reinforcement learning model, wherein the results comprise a measurement of the performance characteristic of the resource collected from performance of the task.

5. The method of claim 3, wherein the reinforcement learning model was trained based on historical and real-time performance data from the available resources, applicable to performance of the task, comprising performance data applicable to at least one of:
an input size of the task,
an output size of the task, and
operations performed during the performance of the task.

6. The method of claim 3, wherein the confidence score comprises a first confidence score, wherein the resource allocation comprises a first resource allocation, wherein the resource comprises a first resource, and wherein the method further comprises:
based on monitoring the performance of the task, updating, by the computing system, the first confidence score; and
based on a change in the first confidence score and a second confidence score based on a second confidence score of the respective confidence scores of the second potential resource allocation, employing, by the computing system, the second potential resource allocation as a second resource allocation, to allocate a second resource for continuing the performance of the task.

7. The method of claim 6, wherein the change in the first confidence score comprises a change in the first confidence score to being below a confidence threshold.

8. The method of claim 7, wherein the confidence threshold was determined based on a criticality of the task and a likelihood of uncertainty applicable to the generating of the respective confidence scores.

9. The method of claim 6, wherein a result of the monitoring of the performance of the task comprises at least one of:
a measurement of a device load of the first resource,
inter-device communication volume between the first resource and other resources other than the first resource,
available memory of the first resource, and
an available compute capacity of the first resource.

10. The method of claim 1, wherein the respective performance predictions comprise at least one of, a prediction of:
a runtime of the performance of the task,
memory usage for the performance of the task, and
a compute total for the performance of the task.

11. The method of claim 1, wherein the confidence score comprises a first confidence score, and further comprising:
based on a difference between the first confidence score of the first potential resource allocation and a second confidence score of the second potential resource allocation, identifying a third resource allocation applicable to the task allocation plan.

12. The method of claim 11, wherein the identifying of the third resource allocation was based on the difference indicating an uncertainty level above an uncertainty threshold.

13. The method of claim 1, wherein the task information comprises first task information, wherein the task comprises a first task, wherein the respective performance predictions comprise a first performance prediction applicable to the first potential resource allocation and a second performance prediction applicable to the second potential resource allocation, wherein the task allocation plan comprises a first task allocation plan, and wherein the method further comprises:
based on second task information corresponding to a second task, identifying, by the computing system, a second task allocation plan comprising a third potential resource allocation for performance of the second task and a fourth potential resource allocation for the performance of the second task, wherein the third potential resource allocation comprises a third performance prediction for the performance of the second task based on the third potential resource allocation and the fourth potential resource allocation, and wherein the fourth potential resource allocation comprises a fourth performance prediction for the performance of the second task based on the third potential resource allocation and the fourth potential resource allocation.

14. The method of claim 13, further comprising:
generating, by the computing system, a directed acyclic graph comprising the first task information, the second task information, and a relationship between the first task information and the second task information.

15. Server equipment, comprising:
at least one memory that stores computer executable instructions; and
at least one processor configured to process the computer executable instructions that, when executed by the at least one processor, facilitate performance of operations, comprising:
receiving a request for a mapping of a task to computing equipment in a cloud-based computer network;
based on task information describing the task and a state of the computing equipment, sampling a reinforcement learning model, resulting in the mapping of the task comprising the mapping of the task to a resource of the computing equipment, wherein the reinforcement learning model:
was trained based on performance data describing a performance of tasks by the computing equipment, and
employs conformal prediction to the mapping of the task, resulting in the mapping of the task comprising a confidence score applicable to results of the mapping of the task; and
updating the reinforcement learning model based on the results, the mapping of the task, and the confidence score.

16. The server equipment of claim 15, wherein the performance data is applicable to at least one of:
an input size of a prior task performed by the computing equipment,
an output size of the prior task performed by the computing equipment, and
an operation performed during performance of the prior task by the computing equipment.

17. The server equipment of claim 15, wherein the resource comprises a first resource, and the mapping of the task comprises a first mapping of the task, and wherein the operations further comprise:
during performance of the task using the first resource, receiving an indication that the performance of the task using the first resource has decreased below a threshold level of performance;
communicating a fallback plan for the performance of the task, comprising:
a second mapping of the task to a second resource of the computing equipment, wherein the updating of the reinforcement learning model based on the results comprises updating the reinforcement learning model further based on the indication that the performance by the first resource decreased below the threshold level of performance, and the fallback plan.

18. A non-transitory machine-readable medium comprising executable instructions that, when executed by at least one processor of a computer system, facilitate performance of operations, the operations comprising:
receiving, from machine learning equipment, at least two initial placement specifications for performance of a computational task by resources of a distributed computer system;
based on conformal prediction model, generating respective likelihood scores for the performance of the computational task in accordance with the at least two initial placement specifications;
based on a result of comparing the respective likelihood scores, selecting an implemented initial placement specification from the at least two placement specifications; and
communicating, to the machine learning equipment, the implemented initial placement specification, a likelihood score of the respective likelihood scores of the implemented initial placement specification, and a measure of a result of the implemented initial placement specification.

19. The non-transitory machine-readable medium of claim 18, wherein the generating of the respective likelihood scores comprises generating a directed acyclic data structure comprising the at least two initial placement specifications, a relationship between the at least two initial placement specifications, and the respective likelihood scores, and wherein the operations further comprise communicating the directed acyclic data structure to the machine learning equipment.

20. The non-transitory machine-readable medium of claim 19, wherein nodes of the directed acyclic data structure comprise operation identifiers applicable to the computational task, wherein the operation identifiers comprise at least one of:
a matrix multiplication identifier,
a convolution identifier, and
an activation identifier; wherein edges of the directed acyclic data structure comprise dependencies between the nodes, and wherein the dependencies comprise at least one of:
an indication of data flow between the nodes, and
an indication of an execution order of operations corresponding to the nodes.
